(19) United States
(12) Patent Application Publication
(10) Pub. No.: US 2022/0001833 A1
(43) Pub. Date: Jan. 6, 2022

(54) WEBBING RETRACTOR

(71) Applicant: KABUSHIKI KAISHA TOKAI-RIKA-DENKI-SEISAKUSHO, Aichi (JP)

(72) Inventors: Tomoya OWAKI, Aichi (JP); Takuhiro SAITO, Aichi (JP); Kazuhiro YAMADA, Aichi (JP); Atsushi NISHINO, Aichi (JP)

(21) Appl. No.: 17/294,806

(22) PCT Filed: Nov. 1, 2019
(86) PCT No.: PCT/JP2019/043117

§ 371 Date: May 18, 2021

(30) Foreign Application Priority Data
Nov. 28, 2018 (JP) 2018-222597

(51) Int. Cl. B60R 22/343; B60R 22/405

(52) U.S. Cl. CPC B60R 22/343; B60R 22/405

(57) ABSTRACT

A webbing retractor includes: a take-up shaft on which a webbing that is applied to a vehicle occupant can be taken-up, and on which the webbing is taken-up due to the take-up shaft being rotated in a take-up direction, and that is rotated in a pull-out direction due to the webbing being pulled-out; a restricting member that, by being operated, restricts rotation of the take-up shaft in the pull-out direction; a sensing section that senses a pulled-out state of the webbing; and a control section that, in a case in which the sensed pulled-out state corresponds to a state in which the webbing is pulled-out to a predetermined position, operates the restricting member and restricts rotation of the take-up shaft.

### TECHNICAL FIELD

The present disclosure relates to a webbing retractor that takes-up a webbing that is applied to a vehicle occupant.

### BACKGROUND ART

A webbing retractor that has an ALR (Automatic Locking Retractor) mechanism is disclosed in Japanese Patent Application Laid-Open (JP-A) No. 2014-141137. This ALR mechanism can operate between a fully pulled-out state in which the webbing is pulled-out as much as possible, and an idle latch state in which a tongue that is provided at the webbing is attached to a buckle in a state in which a vehicle occupant is not seated in the seat. This ALR mechanism is structured to include a gear group that decelerates the rotation of the spool, a cam (control disc) that is operated by the gear group, and a switching pawl that is operated by the cam.

### SUMMARY OF INVENTION

### Technical Problem

On the other hand, an ALR mechanism such as that of JP-A No. 2014-141137 requires changing of the reduction ratio of the gear group and the shape of the cam for each type of vehicle and each seat position, and new parts must be manufactured for each specification of vehicle type and seat position.

In view of the above-described circumstances, an object of the present disclosure is to provide a webbing retractor that can reduce the number of parts for each specification of vehicle type and seat position.

### Solution to Problem

A webbing retractor of a first aspect of the present disclosure comprises: a take-up shaft on which a webbing that is applied to a vehicle occupant can be taken-up, and on which the webbing is taken-up due to the take-up shaft being rotated in a take-up direction, and that is rotated in a pull-out direction due to the webbing being pulled-out; a restricting member that, by being operated, restricts rotation of the take-up shaft in the pull-out direction; a sensing section that senses a pulled-out state of the webbing; and a control section that, in a case in which the sensed pulled-out state corresponds to a state in which the webbing is pulled-out to a predetermined position, operates the restricting member and restricts rotation of the take-up shaft.

In a webbing retractor of a second aspect of the present disclosure, the webbing retractor of the first aspect further comprises: a rotating body that can rotate accompanying rotation of the take-up shaft; and an operation member that operates the restricting member by restricting rotation of the rotating body, wherein, in a case in which the sensed pulled-out state corresponds to a state in which the webbing is pulled-out to a predetermined position, the control section displaces the operation member and restricts rotation of the rotating body.

In a webbing retractor of a third aspect of the present disclosure, in the webbing retractor of the second aspect, the operation member is provided at the rotating body, and also serves as a pawl that, at a time when the rotating body is rotated in the pull-out direction at a predetermined speed or greater, is displaced and anchors the rotating body.

In a webbing retractor of a fourth aspect of the present disclosure, the webbing retractor of the second aspect further comprises: an inertial mass body that can roll due to inertia at a time of vehicle deceleration, wherein the operation member also serves as a lever that hangs over the inertial mass body, and that, due to rolling of the inertial mass body, is displaced and anchors the rotating body.

In a webbing retractor of a fifth aspect of the present disclosure, the webbing retractor of any one of the second aspect through the fourth aspect comprises: an electromagnetic actuator that operates the operation member, wherein the control section energizes the electromagnetic actuator and displaces the operation member.

In a webbing retractor of a sixth aspect of the present disclosure, in the webbing retractor of the fifth aspect, the electromagnetic actuator is a self-holding actuator that, in a case in which the operation member is displaced and rotation of the rotating body is restricted, can maintain a displaced state of the operation member.

In a webbing retractor of a seventh aspect of the present disclosure, in the webbing retractor of any one of the first aspect through the sixth aspect, the sensing section is a rotation angle sensor that detects a rotation angle of the take-up shaft as the pulled-out state, and the control section uses a state, in which the rotation angle has reached a threshold value, as the state in which the webbing is pulled-out to a predetermined position.

In a webbing retractor of an eighth aspect of the present disclosure, in the webbing retractor of any one of the first aspect through the sixth aspect, the sensing section has a pulled-out amount sensor that detects a pulled-out amount of the webbing as the pulled-out state, and the control section uses a state, in which the pulled-out amount has reached a threshold value, as the state in which the webbing is pulled-out to a predetermined position.

### Advantageous Effects of Invention

In the webbing retractor of the first aspect, the webbing is taken-up due to the take-up shaft being rotated in the take-up direction, and the take-up shaft is rotated in the pull-out direction due to the webbing being pulled-out. Further, at this webbing retractor, rotation of the take-up shaft in the pull-out direction is restricted due to the restricting member being operated. Here, the webbing retractor has the ALR mechanism that includes the sensing section that senses the pulled-out state of the webbing, and the control section that effects control that can move the restricting member. Further, due to the control section operating the restricting member in a case in which the webbing is pulled-out to a predetermined position, rotation of the take-up shaft is restricted.

In accordance with the webbing retractor of the first aspect, at the control section, by setting the range of operation of the restricting member with respect to the pulled-out state of the webbing, the number of parts that are needed for each specification of vehicle type and seat position can be reduced.

In the webbing retractor of the second aspect, the rotating body can rotate accompanying the rotation of the take-up shaft. Due to the operation member being displaced and rotation of the rotating body being restricted, rotation of the take-up shaft in the pull-out direction is restricted. Further, at the webbing retractor, in a case in which the webbing is pulled-out to a predetermined position, due to the control section displacing the operation member, rotation of the rotating body is restricted, and, accompanying the restricting of rotation of the rotating body, the restricting member is operated, and rotation of the take-up shaft is restricted.

In the webbing retractor of the second aspect, because rotation of the take-up shaft is restricted via the rotating body, at the operation member, lightening of weight can be devised as compared with a restricting member that directly receives load from the webbing. Therefore, in accordance with this webbing retractor, the operation member can be displaced by a small operating force.

The webbing retractor of the third aspect has a WSIR mechanism that is operated due to the rotational acceleration of the take-up shaft in the pull-out direction exceeding a predetermined magnitude. The operation member that structures the ALR mechanism also serves as a pawl that operates the WSIR mechanism. Accordingly, in accordance with this webbing retractor, an increase in the number of parts can be suppressed.

The webbing retractor of the fourth aspect has a VSIR mechanism that is operated due to the acceleration of the vehicle exceeding a predetermined magnitude. The operation member that structures the ALR mechanism also serves as the lever that operates the VSIR mechanism. Accordingly, in accordance with this webbing retractor, an increase in the number of parts can be suppressed.

In accordance with the webbing retractor of the fifth aspect, a mechanical structure can be eliminated by realizing the ALR mechanism that operates electromagnetically, and simplification of the device can be devised.

In accordance with the webbing retractor of the sixth aspect, the operated state of the ALR mechanism can be maintained even in a case in which the ignition is turned OFF.

In accordance with the webbing retractor of the seventh aspect, the pulled-out state of the webbing is acquired from the rotation angle of the take-up shaft. In accordance with this webbing retractor, the rotation angle sensor can be provided at any rotating member that rotates interlockingly with the take-up shaft. Therefore, assembly into the device is easy, and downsizing of the device can be devised.

In a webbing retractor of an eighth aspect, the pulled-out amount of the webbing itself is used in acquiring the pulled-out state of the webbing. In accordance with this webbing retractor, the ALR mechanism can be operated precisely because it is not affected by the taken-up state of the webbing on the take-up shaft.

### BRIEF DESCRIPTION OF THE DRAWINGS

FIG. 1 is an exploded perspective view showing a webbing retractor in an exploded manner.

FIG. 2 is a rear view showing main portions of the webbing retractor.

FIG. 3 is a rear view that corresponds to FIG. 2 and shows main portions of the webbing retractor in a state in which a W-pawl has been swung.

FIG. 4 is a cross-sectional view showing a cross-section of main portions of the webbing retractor that is cut along line 4-4 shown in FIG. 2.

FIG. 5 is a flowchart of processing relating to operation of an ALR mechanism.

FIG. 6 is a block drawing of webbing retractors relating to first, second and fourth embodiments.

FIG. 7 is a block drawing of a webbing retractor relating to a third embodiment.

### DESCRIPTION OF EMBODIMENTS

### First Embodiment

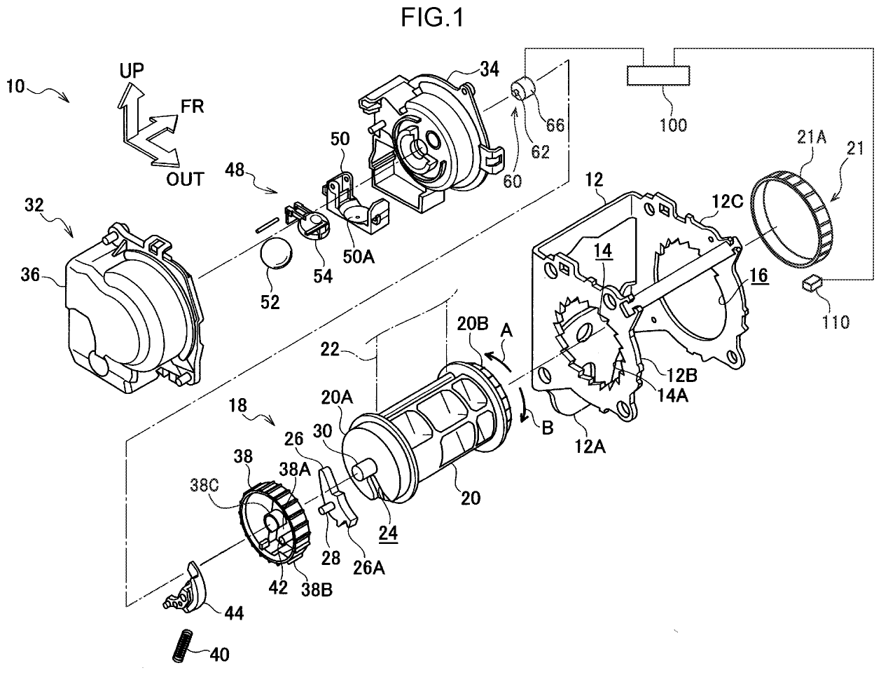

A webbing retractor 10 relating to a first embodiment of the present disclosure is shown in FIG. 1 in an exploded perspective view that is seen from an obliquely outer and upper direction. Note that, in the drawings, the vehicle front side in a state in which the webbing retractor 10 is mounted to a vehicle is indicated by arrow FR, the vehicle transverse direction outer side is indicated by arrow OUT, and the vehicle upper side is indicated by arrow UP. Further, in the following description, when simply longitudinal and vertical directions are used, they refer to the longitudinal of the vehicle longitudinal direction and the vertical of the vehicle vertical direction.

As shown in FIG. 1, the webbing retractor 10 of the present embodiment has a frame 12 that is formed in a substantial U-shape as seen from the vehicle upper side. This frame 12 has a back plate 12A that extends in the vehicle vertical direction with the vehicle transverse direction being the thickness direction thereof, and a leg plate 12B and a leg plate 12C that respectively are bent from the vehicle longitudinal direction both end portions of the back plate 12A and extend toward the vehicle transverse direction outer side and that are disposed so as to face one another. Further, the webbing retractor 10 is set at the vehicle body due to the back plate 12A of the frame 12 being fixed to the vehicle body.

A placement hole 14 and a placement hole 16 that are substantially circular are formed in the leg plate 12B and the leg plate 12C, respectively. The placement hole 14 and the placement hole 16 face one another in the vehicle longitudinal direction. Further, ratchet teeth 14A (inner teeth), which structure a locking mechanism 18 that serves as a restricting means, are formed at the entire outer periphery of the placement hole 14.

A spool 20, which is substantially solid cylindrical and serves as a take-up shaft, is provided between the leg plate 12B and the leg plate 12C of the frame 12. One end 20A at the rear side (the leg plate 12B side) of the spool 20 is disposed within the placement hole 14 of the leg plate 12B, and another end 20B at the front side (the leg plate 12C side) of the spool 20 is disposed within the placement hole 16 of the leg plate 12C. Due thereto, the spool 20 can rotate in the peripheral direction in a state in which the axial direction of the spool 20 is parallel to the longitudinal direction. Note that when merely axial direction, radial direction and peripheral direction are used hereinafter, they refer to the axial direction, the radial direction and the peripheral direction of the spool unless otherwise indicated.

The proximal end side of a webbing 22 (belt) that is shaped as an elongated belt is anchored on the spool 20, and the webbing 22 is taken-up onto the spool 20 from the proximal end side. When the spool 20 is rotated in the take-up direction (the direction of arrow A in FIG. 1 that is one way in the peripheral direction), the webbing 22 is taken-up onto the spool 20. On the other hand, when the webbing 22 is pulled-out from the spool 20, the spool 20 is rotated in the pull-out direction (the direction of arrow B in FIG. 1 that is another way in the peripheral direction). The webbing 22 extends toward the upper side from the frame 12, and the webbing 22 is applied to the vehicle occupant who is seated in a vehicle seat.

A spiral spring that serves as a take-up urging means is connected to the another end 20B of the spool 20, and the spiral spring is disposed at the front side of the frame 12 (the front side of the leg plate 12C). The spiral spring urges the spool 20 in the take-up direction, and, due thereto, urging force in the take-up direction of the spool 20 is applied to the webbing 22. Therefore, at the time when the webbing 22 is applied to the vehicle occupant, the slack in the webbing 22 is eliminated due to the urging force of the spiral spring, and, at the time when the application of the webbing 22 to the vehicle occupant is released, the webbing 22 is taken-up onto the spool 20 due to the urging force of the spiral spring.

Further, a ring 21 which is shaped as a cylindrical tube is connected to the another end 20B of the spool 20. Plural projecting portions 21A are disposed at the ring 21 at a uniform interval along the peripheral direction. Moreover, a rotation angle sensor 110, which serves as a sensing section that senses the rotation angle of the ring 21, is provided at a position that is close to the ring 21. The rotation angle sensor 110 is electrically connected to a control device 100 that is described later. The rotation angle sensor 110 of the present embodiment is a magnetic type, and can detect the rotation angle by detecting the change in the magnetic flux by a magnetic sensor that is set close to the projecting portions 21A of the ring 21. Because the ring 21 is connected to the spool 20 as described above, by detecting the angle of the ring 21, the control device 100 can acquire the rotation angle of the spool. Note that the rotation angle sensor 110 is not limited to a magnetic sensor, and may be an optical sensor.

An accommodating hole 24, whose outer side in the radial direction of the spool 20 is open, is formed in the one end 20A of the spool 20. A lock pawl 26, which is shaped as an elongated plate and serves as a restricting member that structures the locking mechanism 18, is movably accommodated in the accommodating hole 24. Further, a lock tooth 26A is formed at one end of the lock pawl 26. An operation shaft 28 that is solid cylindrical is provided integrally with the lock pawl 26, and the operation shaft 28 projects-out toward the rear side from the lock pawl 26.

A rotation shaft 30 that is solid cylindrical is provided integrally with the axially central portion of the one end 20A of the spool 20. The rotation shaft 30 projects-out toward the rear side from the spool 20, and is disposed coaxially with the spool 20.

A sensor mechanism 32 that structures the locking mechanism 18 is provided at the rear side of the frame 12 (the rear side of the leg plate 12B).

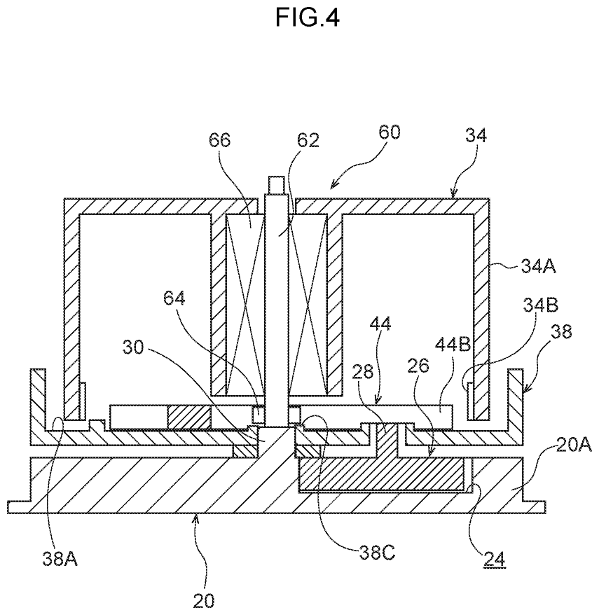

The sensor mechanism 32 has a sensor holder 34 that is formed by using a resin material, and that is substantially shaped as a cylindrical tube with a bottom whose front side (leg plate 12B side) is open. This sensor holder 34 is fixed to the leg plate 12B. An inner tubular portion 34A (see FIG. 4) that is shaped as a cylindrical tube is formed at the inner side of the sensor holder 34. The inner tubular portion 34A is disposed coaxially with the spool 20.

A sensor cover 36, which is formed by using a resin material and is substantially shaped as a cylindrical tube with a bottom whose front side is open, is provided at the rear side of the sensor holder 34 (the side opposite the leg plate 12B). The sensor cover 36 is fixed to the leg plate 12B in a state in which the sensor holder 34 is accommodated at the interior of the sensor cover 36.

A V-gear 38 that serves as a rotating body is provided within the sensor holder 34. This V-gear 38 is formed by using a resin material and is shaped as a cylindrical tube with a bottom whose rear side is open. A tubular portion 38C that is formed in the shape of a tube stands upright at the axially central portion of a bottom wall 38A of the V-gear 38. Due to the rotation shaft 30 of the spool 20 being inserted in the tubular portion 38C, the V-gear 38 can rotate with respect to the spool 20.

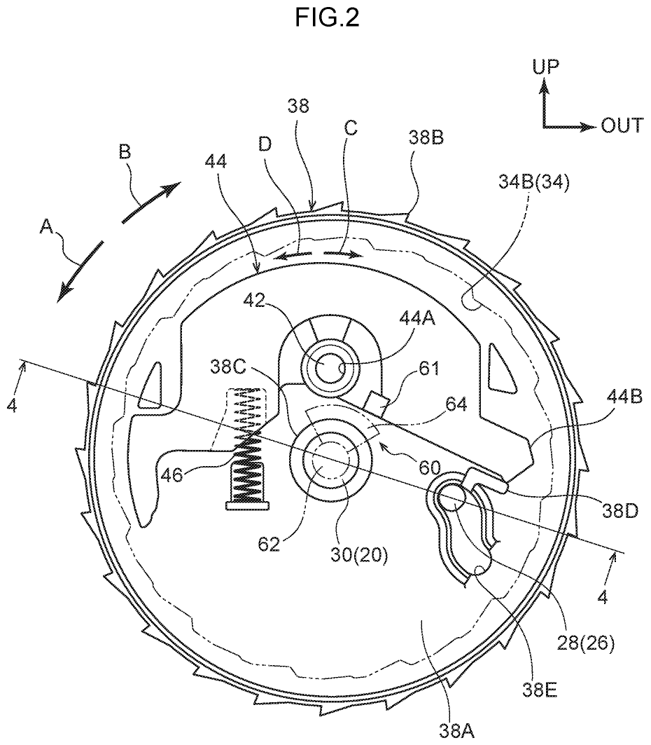

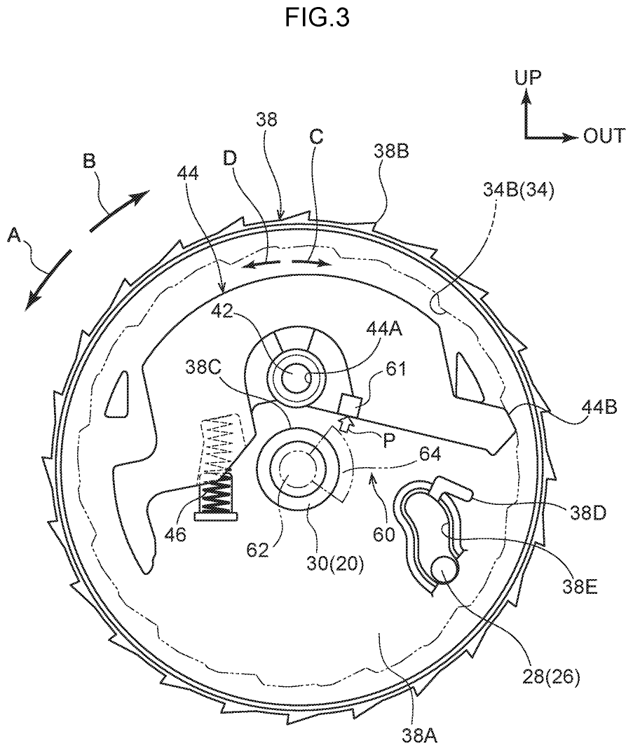

An operation groove 38E that is elongated is formed in the bottom wall 38A of the V-gear 38 (see FIG. 2 and FIG. 3). The operation shaft 28 of the lock pawl 26 is inserted in the operation groove 38E. A compression coil spring 40 is interposed between the V-gear 38 and the one end 20A of the spool 20. The compression coil spring 40 urges the V-gear 38 in the pull-out direction with respect to the spool 20 (urges the spool 20 in the take-up direction with respect to the V-gear 38), and causes the operation shaft 28 to about a length direction one end of the operation groove 38E. Due thereto, rotation of the V-gear 38 in the pull-out direction with respect to the spool 20 due to the urging force of the compression coil spring 40 is stopped, and, accompanying the rotation of the spool 20, the V-gear 38 can rotate around the rotation shaft 30 of the spool 20. Further, ratchet teeth 38B (outer teeth) are formed at the entire outer periphery of the V-gear 38.

A swinging shaft 42 that is solid cylindrical stands erect at the bottom wall 38A of the V-gear 38. The swinging shaft 42 is disposed at the radial direction outer side with respect to the central axis of the V-gear 38. Further, the central axis of the swinging shaft 42 and the central axis of the V-gear 38 are parallel.

As shown in FIG. 2, a W-pawl 44, which serves as an operation member and a pawl, is supported at the swinging shaft 42 so as to be able to swing (be displaced). In detail, as seen in a front view, the W-pawl 44 is formed in a U-shape whose V-gear 38 axially central portion side is open. A swinging shaft insertion hole 44A, into which the swinging shaft 42 is inserted, is formed at the intermediate portion in the peripheral direction (the peripheral direction of the V-gear 38) of the W-pawl 44. Further, the end portion at the peripheral direction another side of the W-pawl 44 is an engaging portion 44B that engages with an engaged portion 34B at the distal end of the inner tubular portion 34A of the sensor holder 34. Moreover, a permanent magnet 61 that is rectangular parallelepiped is fit-together with a portion of the W-pawl 44 that is at the peripheral direction another side and that is toward the swinging shaft insertion hole 44A. This permanent magnet 61 is disposed so as to face an excitation portion 64 that is described later.

Further, a return spring 46 is interposed between the W-pawl 44 and the V-gear 38. The return spring 46 urges the W-pawl 44 in the return direction (the direction of arrow C). Moreover, swinging of the W-pawl 44 in the return direction due to the urging force of the return spring 46 is stopped by a restricting projecting portion 38D that is provided at the V-gear 38.

When the V-gear 38 is rotated in the pull-out direction, inertial force in the take-up direction with respect to the V-gear 38 is applied to the W-pawl 44. Due thereto, the W-pawl 44 starts to swing in the operating direction (the direction of arrow D) with respect to the V-gear 38. Moreover, at the time when the V-gear 38 is rotated in the pull-out direction rapidly, the inertial force that acts on the W-pawl 44 becomes greater than the urging force of the return spring 46. Due thereto, the W-pawl 44 is swung in the operating direction with respect to the V-gear 38, and the engaging portion 44B of the W-pawl 44 engages with the engaged portion 34B of the sensor holder 34. Namely, due to the V-gear 38 being anchored by the W-pawl 44, rotation of the V-gear 38 in the pull-out direction is stopped.

As shown in FIG. 1, an acceleration sensor 48 is provided at the lower end portion of the sensor holder 34. The acceleration sensor 48 has a substantially U-shaped housing 50 whose upper side is open, as seen in a vehicle front view. A curved surface 50A that is concave is formed at the top surface of the bottom wall of the housing 50. A ball 52 that is spherical and serves as an inertial mass body is placed on the curved surface 50A. A substantially plate-shaped lever 54 that serves as a lever is placed on the upper side of the ball 52. At the proximal end thereof, the lever 54 is rotatably supported at a side wall of the housing 50. The V-gear 38 is disposed at the upper side of the distal end of the lever 54. Due to the ball 52 rolling on the curved surface 50A of the housing 50 and rising-up, the lever 54 is rotated toward the upper side. Due thereto, the distal end of the lever 54 meshes-with (anchors on) the ratchet teeth 38B of the V-gear 38, and rotation of the V-gear 38 in the pull-out direction is stopped.

As shown in FIG. 4, an interlocking shaft 62 is disposed at the axially central portion of the inner tubular portion 34A at the inner side of the sensor holder 34. This interlocking shaft 62 is disposed coaxially with the rotation shaft 30 of the spool 20, and is connected to the rotation shaft 30. Therefore, the interlocking shaft 62 rotates interlockingly with the spool 20. Further, as shown in FIG. 2, the excitation portion 64, which is fan-shaped as seen from the axial direction and projects-out from the interlocking shaft 62 toward the swinging shaft 42 (the W-pawl 44) side, is provided in a vicinity of the end portion at the front side (the rotation shaft 30 side) of the interlocking shaft 62. The interlocking shaft 62 and the excitation portion 64 of the present embodiment are metal conductors of iron or the like, and the interlocking shaft 62 and the excitation portion 64 are formed integrally. Moreover, a coil 66 is provided at the inner tubular portion 34A so as to surround the periphery of the interlocking shaft 62. This coil 66 is electrically connected to the control device 100 that is described later. In the present embodiment, an electromagnetic actuator 60, which operates by the magnetic force of an electromagnet, is formed by the permanent magnet 61 that is provided at the W-pawl 44, and the interlocking shaft 62, the excitation portion 64 and the coil 66 that are provided at the inner tubular portion 34A.

For example, in a case in which the excitation portion 64 side of the permanent magnet 61 is the N pole, due to the coil 66 being energized and the rotation shaft 30 side of the interlocking shaft 62 (i.e., the excitation portion 64) being excited so as to become the N pole, repulsive force arises between the permanent magnet 61 and the excitation portion 64 (refer to arrow P in FIG. 3). As described above, usually, the W-pawl 44 is urged in the return direction (the direction of arrow C) by the return spring 46 (see FIG. 2). However, due to the permanent magnet 61 and the excitation portion 64 repelling one another, the W-pawl 44 starts to swing in the operating direction (the direction of arrow D) with respect to the V-gear 38. Then, when the repulsive force that is applied to the permanent magnet 61 becomes greater than the urging force of the return spring 46, the W-pawl 44 to which the permanent magnet 61 is fixed is swung in the operating direction with respect to the V-gear 38, and the engaging portion 44B of the W-pawl 44 engages with the engaged portion 34B of the sensor holder 34.

As described above, at the time when rotation of the V-gear 38 in the pull-out direction is stopped, when the spool 20 is rotated in the pull-out direction with respect to the V-gear 38 against the urging force of the compression coil spring 40, the operation shaft 28 of the lock pawl 26 is moved toward a length direction another end side of the operation groove 38E of the V-gear 38, and the lock pawl 26 is moved toward the radial direction outer side of the spool 20 (the one end 20A). Due thereto, the lock tooth 26A of the lock pawl 26 meshes with the ratchet teeth 14A of the frame 12 (the leg plate 12B), and rotation of the spool 20 in the pull-out direction is locked (restricted). As a result, pulling-out of the webbing 22 from the spool 20 is locked (restricted).

Note that, as shown in FIG. 3, when the spool 20 is rotated in the pull-out direction with respect to the V-gear 38, the interlocking shaft 62 also rotates interlockingly with the spool 20. However, in this case as well, the excitation portion 64 is disposed so as to face the permanent magnet 61 that is provided at the W-pawl 44.

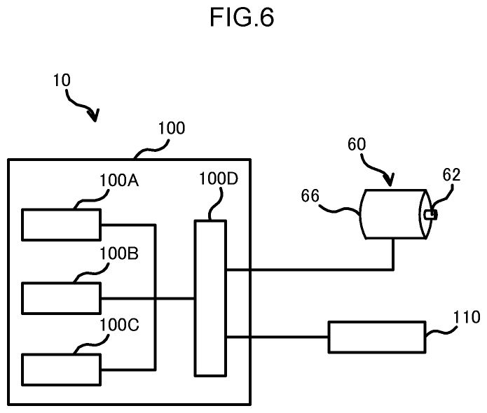

As shown in FIG. 1, the control device 100, which serves as a control section and controls the electromagnetic actuator 60, is provided at the webbing retractor 10 of the present embodiment. As shown in FIG. 6, the control device 100 has a CPU (Central Processing Unit) 100A, a ROM (Read Only Memory) 100B, a RAM (Random Access Memory) 100C, and an input/output interface (I/O) 100D, and these respective portions are respectively connected via a bus. In addition to the coil 66 of the electromagnetic actuator 60, at least the rotation angle sensor 110 is electrically connected to the I/O 100D of the control device 100.

In a case in which the rotation angle of the spool 20 that is sensed at the rotation angle sensor 110 corresponds to a state in which the webbing 22 has been pulled-out to a predetermined position, the control device 100 operates the electromagnetic actuator 60, and swings the W-pawl 44 in the operating direction with respect to the V-gear 38. Here, the predetermined position of the webbing 22 is a position that corresponds to the fully pulled-out state in which the webbing 22 is pulled-out the most.

Namely, the control device 100 operates the electromagnetic actuator 60 at the time when the webbing 22 is pulled-out and reaches its fully pulled-out state. Due to the electromagnetic actuator 60 operating and the W-pawl 44 engaging with the V-gear 38, pulling-out of the webbing 22 from the spool 20 is restricted. On the other hand, the ratchet teeth 14A of the frame 12 (the leg plate 12B) permit rotation of the spool 20 in the take-up direction, and the engaged portion 34B of the sensor holder 34 permits rotation of the V-gear 38 in the take-up direction. Therefore, in accordance with the present embodiment, after the webbing 22 is applied to a child seat, fixing of the child seat can be carried out by operating the ALR mechanism.

As described above, in the present embodiment, a WSIR mechanism, which is operated due to the rotational acceleration of the spool 20 in the pull-out direction exceeding a predetermined magnitude, is structured by the W-pawl 44, the V-gear 38 and the locking mechanism 18. Further, a VSIR mechanism, which is operated due to the acceleration of the vehicle exceeding a predetermined magnitude, is structured by the acceleration sensor 48 and the locking mechanism 18. Moreover, an ALR mechanism is structured by including the electromagnetic actuator 60, the rotation angle sensor 110 and the control device 100, in addition to the W-pawl 44, the V-gear 38 and the locking mechanism 18 that structure the WSIR mechanism.

(Operation and Effects of Present Embodiment)

Operation and effects of the present embodiment are described next.

In the webbing retractor 10 of the above-described structure, due to the webbing 22 being tensed, and the spool 20 and the V-gear 38 being rotated in the pull-out direction against the urging force of the spiral spring, the webbing 22 is pulled-out from the spool 20, and is set in a latched state and is applied to the vehicle occupant.

A case in which the VSIR mechanism operates is as follows. Namely, at the time when the vehicle rapidly decelerates, at the acceleration sensor 48, due to the ball 52 rolling on the curved surface 50A of the housing 50 and rising-up, the lever 54 is rotated toward the upper side, and the distal end meshes with (anchors on) the ratchet teeth 38B of the V-gear 38. Due thereto, rotation of the V-gear 38 in the pull-out direction is stopped.

Further, a case in which the WSIR mechanism operates is as follows. Namely, at the time when the vehicle rapidly decelerates, due to the vehicle occupant being moved by inertial force, the webbing 22 is pulled-out from the spool 20 by the vehicle occupant, and the spool 20 and the V-gear 38 are rotated rapidly in the pull-out direction. Further, at the time when the V-gear 38 is rotated rapidly in the pull-out direction, the W-pawl 44 is swung in the operating direction with respect to the V-gear 38, and the engaging portion 44B of the W-pawl 44 engages with the engaged portion 34B of the sensor holder 34, and rotation of the V-gear 38 in the pull-out direction is stopped.

At the time when rotation of the V-gear 38 in the pull-out direction is stopped, due to the spool 20 being rotated in the pull-out direction with respect to the V-gear 38 against the urging force of the compression coil spring 40, the operation shaft 28 of the lock pawl 26 is moved toward the length direction another end side of the operation groove 38E of the V-gear 38, and the lock pawl 26 is moved toward the radial direction outer side of the spool 20. Due thereto, the lock tooth 26A of the lock pawl 26 meshes with the ratchet teeth 14A of the frame 12, and rotation of the spool 20 in the pull-out direction is locked. Due thereto, pulling-out of the webbing 22 from the spool 20 is locked, and the vehicle occupant is restrained by the webbing 22.

On the other hand, when the application of the webbing 22 to the vehicle occupant is cancelled, the spool 20 and the V-gear 38 are rotated in the take-up direction by the urging force of the spiral spring, and the webbing 22 is taken-up onto the spool 20.

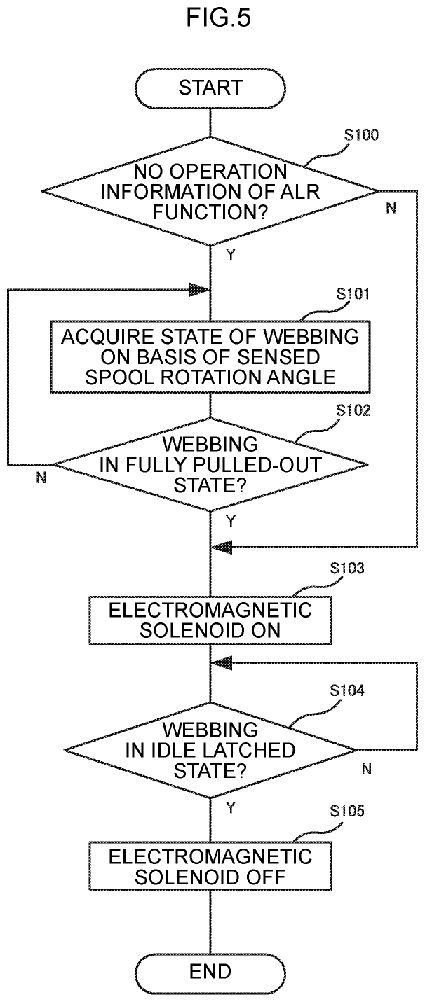

The processing by which the control device 100 operates the ALR mechanism is described hereinafter by using the flowchart of FIG. 5.

As shown in FIG. 5, when the ignition of the vehicle is turned ON, in step S100, the control device 100 executes the processing of judging whether or not operation information of the ALR mechanism is stored in the memory. Here, operation information of the ALR mechanism is information that is stored in the memory in a case in which the ALR mechanism was operated at the time when the ignition was turned OFF the previous time. If the control device 100 judges that operation information of the ALR mechanism it not stored, the control device 100 moves on to step S101. On the other hand, if the control device 100 judges that operation information of the ALR mechanism is stored, the control device 100 moves on to step S103.

In step S101, the control device 100 acquires the state of the webbing 22 on the basis of the rotation angle of the spool 20 that is sensed at the rotation angle sensor 110. The state of the webbing 22 may be acquired as the total rotation angle of the spool 20, or may be acquired as the pulled-out amount of the webbing 22 that is computed on the basis of the rotation angle of the spool 20. Then, the control device 100 moves on to step S102.

In step S102, the control device 100 judges whether or not the state of the webbing 22 is the fully pulled-out state. If the state of the webbing 22 is the fully pulled-out state, the control device 100 moves on to step S103. On the other hand, if the state of the webbing 22 is not the fully pulled-out state, the control device 100 returns to step S101. Namely, the control device 100 repeats step S101 and step S102 until the webbing 22 is in the fully pulled-out state.

In step S103, the control device 100 turns the electromagnetic actuator 60 ON. Namely, the control device 100 energizes the coil 66 and swings the W-pawl 44 in the operating direction (the direction of arrow D in FIG. 3) with respect to the V-gear 38. Thereafter, the flow of operations of the ALR mechanism is similar to the case in which the WSIR mechanism operates. Then, the control device 100 moves on to step S104.

In step S104, the control device 100 judges whether or not the state of the webbing 22 is the idle latch state. If the state of the webbing 22 is the idle latch state, the control device 100 moves on to step S105. On the other hand, if the state of the webbing 22 is not the idle latch state, the control device 100 repeats step S104. Namely, the control device 100 causes processing to stand-by until the webbing 22 enters into the idle latch state.

In step S105, the control device 100 turns the electromagnetic actuator 60 OFF. Namely, the control device 100 stops the energizing of the coil 66, and swings the W-pawl 44 in the return direction (the direction of arrow C in FIG. 3) with respect to the V-gear 38 by the urging force of the return spring 46. Due thereto, operation of the ALR mechanism ends. Further, the processing of operating the ALR mechanism ends.

As described above, the webbing retractor 10 of the present embodiment has the ALR mechanism that includes the rotation angle sensor 110 that senses the pulled-out amount of the webbing 22, and the control device 100 that can move the W-pawl 44. In accordance with the webbing retractor 10 of the present embodiment, an ALR mechanism that can correspond to plural, different specifications can be obtained by, at the control device 100, setting the range of operation of the W-pawl 44 with respect to the pulled-out state of the webbing 22. Further, the range of operation of the W-pawl 44 is not limited to, as described above, a case of operating the ALR mechanism when the webbing 22 is in the fully pulled-out state, and ending operation of the ALR mechanism when the webbing 22 returns to the idle latch state. For example, the ALR mechanism may be operated when the webbing 22 is pulled-out approximately half-way, and operation of the ALR mechanism may be ended when the webbing 22 is taken-up completely. As described above, in accordance with the present embodiment, because the ALR mechanism does not require mechanical parts that differ for each specification of vehicle type and seat position, an increase in the number of parts at the device overall can be suppressed.

In particular, in the present embodiment, by realizing the ALR mechanism that operates electromagnetically by the electromagnetic actuator 60, mechanical structures can be eliminated, and simplification of the device can be devised.

Moreover, in accordance with the present embodiment, because rotation of the spool 20 is restricted via the V-gear 38, the W-pawl 44 is light-weight as compared with the lock pawl 26 that receives load from the webbing 22. Therefore, in accordance with the present embodiment, the W-pawl 44 can be swung by an operating force (magnetic force) that is small as compared with a case of operating the lock pawl 26.

Further, the webbing retractor 10 of the present embodiment has the WSIR mechanism that is operated due to the rotational acceleration of the spool 20 in the pull-out direction exceeding a predetermined magnitude, and the W-pawl 44 is used at both the ALR mechanism and the WSIR mechanism. In accordance with the webbing retractor 10 of the present embodiment, an increase in the number of parts can be suppressed.

Note that the ALR mechanism of the present embodiment operates due to the W-pawl 44 swinging due to the electromagnetic actuator 60, but the W-pawl 44 that serves as the WSIR mechanism can swing even if problems arise with the electrical system (the control device 100, the rotation angle sensor 110 and the electromagnetic actuator 60). Namely, even if there is trouble with the ALR mechanism, the function of the WSIR mechanism can be ensured.

Further, in the webbing retractor 10 of the present embodiment, the rotation angle of the spool 20 that is sensed by the rotation angle sensor 110 is used in the operation control of the ALR mechanism. Namely, the control device 100 operates the electromagnetic actuator 60 in a case in which the rotation angle of the spool 20 reaches an angle that corresponds to the fully pulled-out state. In the present embodiment, the angle corresponding to the fully pulled-out state corresponds to the “threshold value” that is the condition for operation of the electromagnetic actuator 60, and a case in which the rotation angle of the spool 20 reaches the angle corresponding to the fully pulled-out state corresponds to the “state in which the webbing is pulled-out to a predetermined position”.

Moreover, in accordance with the present embodiment, the rotation angle sensor 110 can be provided at any rotating member that rotates interlockingly with the spool 20. Therefore, assembly into the device is easy, and downsizing of the device can be devised. Further, accompanying the downsizing, an improvement in the ability to be installed in a vehicle can be devised, and further, countermeasures against external disturbances with respect to foreign objects are easy.

### Second Embodiment

In the first embodiment, a structure (the W-pawl 44) that is a portion of the ALR mechanism is also used for the WSIR mechanism, but, in the second embodiment, is also used for the VSIR mechanism. Concretely, the webbing retractor 10 of the second embodiment has a VSIR mechanism that is operated due to the acceleration of the vehicle exceeding a predetermined magnitude, and the lever 54 of the acceleration sensor 48 is used at both the ALR mechanism and the WSIR mechanism. Here, the lever 53 corresponds to the operation member and the lever. Note that, in the present embodiment, operation of the ALR mechanism is controlled due to the lever 54 being rotated by the electromagnetic actuator 60. In accordance with the webbing retractor 10 of the present embodiment, an increase in the number of parts can be suppressed.

Note that the ALR mechanism of the present embodiment operates due to the lever 54 rotating due to the electromagnetic actuator 60, but the lever 54 that serves as the VSIR mechanism can swing even if problems arise with the electrical system (the control device 100, the rotation angle sensor 110 and the electromagnetic actuator 60). Namely, even if there is trouble with the ALR mechanism, the function of the VSIR mechanism can be ensured.

### Third Embodiment

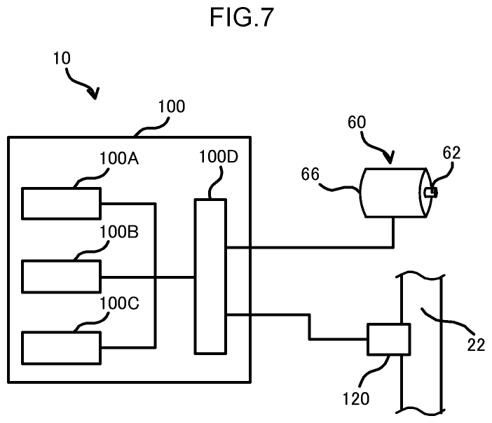

As shown in FIG. 7, in the webbing retractor 10 of the third embodiment, a pulled-out amount sensor 120, which senses the pulled-out amount of the webbing 22, is set on the path of the webbing 22 such as at the upper portion of the frame 12 or the like. For example, a laser displacement meter can be used as the pulled-out amount sensor 120. Further, the pulled-out amount sensor 120 of the present embodiment is electrically connected to the control device 100, and the pulled-out amount of the webbing 22 that is acquired by the pulled-out amount sensor 120 is used in controlling operation of the ALR mechanism. Note that, in the present embodiment, the sensor that provides input to the control device 100 is changed from the rotation angle sensor 110 of the first embodiment to the pulled-out amount sensor 120, and the remaining structures are the same as those of the first embodiment. Namely, the control device 100 operates the electromagnetic actuator 60 in a case in which the pulled-out amount of the webbing 22 reaches a pulled-out amount that corresponds to the fully pulled-out state. In the present embodiment, the pulled-out amount itself that corresponds to the fully pulled-out state corresponds to the “threshold value” that is the condition for operation of the electromagnetic actuator 60, and a case in which the pulled-out amount of the webbing 22 reaches the pulled-out amount corresponding to the fully pulled-out state corresponds to the “state in which the webbing is pulled-out to a predetermined position”.

In the webbing retractor 10 of the present embodiment, the pulled-out amount of the webbing 22 is used as is in acquiring the pulled-out state of the webbing 22. In accordance with the present embodiment, the ALR mechanism can be operated precisely because it is not affected by the taken-up state of the webbing 22 on the spool 20.

### Fourth Embodiment

In a fourth embodiment, the electromagnetic actuator 60 of the first embodiment is made to be a self-holding actuator. In the present embodiment, as seen from the axial direction of the V-gear 38, a magnet for holding is provided at the bottom wall 38A that faces the permanent magnet 61 of the W-pawl 44 that swings in the operating direction. This magnet for holding is disposed such that the poles thereof are the reverse of the poles of the facing permanent magnet 61. Namely, there is a structure in which, in a case in which the W-pawl 44 swings and the permanent magnet 61 faces the magnet for holding, mutually attracting forces arise.

At the electromagnetic actuator 60 of the present embodiment, at the time of operation of the ALR mechanism, the W-pawl 44 can be swung due to the coil 66 being energized by current of a predetermined direction. Further, when the repulsive force from the excitation portion 64 and the attracting force from the magnet for holding that are applied to the permanent magnet 61 become greater than the urging force of the return spring 46, the W-pawl 44, to which the permanent magnet 61 is fixed, is swung in the operating direction with respect to the V-gear 38, and the engaging portion 44B of the W-pawl 44 engages with the engaged portion 34B of the sensor holder 34.

Here, in a case in which the attracting force from the magnet for holding that is applied to the permanent magnet 61 becomes greater than the urging force of the return spring 46, even if energizing of the coil 66 is stopped, the W-pawl 44 is held at the operating direction side. Namely, the displaced state of the W-pawl 44 is maintained by the magnet for holding. Further, in a case of ending the operation of the ALR mechanism, the coil 66 is energized by current that is in the direction opposite to the predetermined direction, and an attracting force that is larger than the attracting force from the magnet for holding is applied from the excitation portion 64 to the permanent magnet 61. Due thereto, the W-pawl 44 can be swung in the return direction.

In this way, in accordance with the webbing retractor 10 of the present embodiment, the operated state of the ALR mechanism can be maintained even in a case in which the ignition is turned OFF.

(Other Points)

The webbing retractors 10 of the above-described respective embodiments are structured so as to forcibly swing the W-pawl 44 by the electromagnetic actuator 60. Accordingly, it is possible for the control device 100 to receive a signal from the acceleration sensor that is provided at the vehicle side, and, on the basis of this signal, operate the electromagnetic actuator 60 and swing the W-pawl 44. Due thereto, the VSIR mechanism that uses the acceleration sensor 48 can be omitted. Further, the pull-out speed of the webbing 22 can be computed from the rotation angle of the spool 20 that is sensed by the rotation angle sensor 110. Therefore, the control device 100 can, on the basis of the computed pull-out speed of the webbing 22, operate the electromagnetic actuator 60 and swing the lever 54. Due thereto, the WSIR mechanism can be simplified or omitted.

Note that, although the electromagnetic actuator 60 of the above-described respective embodiments directly operates the W-pawl 44 by magnetic force of an electromagnet, it is not limited to this, and may be a solenoid that operates the W-pawl 44 by the projecting-out of a movable iron core (a plunger).

The sensor that is used in the control by which the control device 100 operates the ALR mechanism is not limited to the above-described rotation angle sensor and pulled-out amount sensor. For example, a displacement meter that can measure the outermost diameter of the webbing 22 that is wound on the spool 20 may be provided, and the control device 100 may operate the ALR mechanism in a case in which the outermost diameter of the webbing 22 that is sensed by this displacement meter falls below a threshold value.

In the webbing retractors 10 of the above-described respective embodiments, the control device 100 controls the operated state of the ALR mechanism by sensing the pulled-out state of the webbing 22, i.e., the rotation angle of the spool 20 or the pulled-out amount of the webbing 22, but is not limited to this. For example, an electric switch may be provided at a predetermined position within the vehicle, and the control device 100 may operate the ALR mechanism in accordance with the operation of the switch by a vehicle occupant.

Although embodiments of the present disclosure have been described above, the present disclosure is not limited to the above, and can of course be implemented by being modified in various ways other than the above.

The disclosure of Japanese Patent Application No. 2018-222597 filed on Nov. 28, 2018 is, in its entirety, incorporated by reference into the present specification.

### EXPLANATION OF REFERENCE NUMERALS

10 . . . webbing retractor, 20 . . . spool (take-up shaft), 22 . . . webbing, 26 . . . lock pawl (restricting member), 38 . . . V-gear (rotating body), 44 . . . W-pawl (operation member, pawl), 52 . . . ball (inertial mass body), 54 . . . lever (operation member, lever), 60 . . . electromagnetic actuator, 100 . . . control device (control section), 110 . . . rotation angle sensor (sensing section)

1. A webbing retractor comprising:
a take-up shaft on which a webbing that is applied to a vehicle occupant can be taken-up, and on which the webbing is taken-up due to the take-up shaft being rotated in a take-up direction, and that is rotated in a pull-out direction due to the webbing being pulled-out;
a restricting member that, by being operated, restricts rotation of the take-up shaft in the pull-out direction;
a sensing section that senses a pulled-out state of the webbing; and
a control section that, in a case in which the sensed pulled-out state corresponds to a state in which the webbing is pulled-out to a predetermined position, operates the restricting member and restricts rotation of the take-up shaft.

2. The webbing retractor of claim 1, further comprising:
a rotating body that can rotate accompanying rotation of the take-up shaft; and
an operation member that operates the restricting member by restricting rotation of the rotating body,
wherein, in a case in which the sensed pulled-out state corresponds to a state in which the webbing is pulled-out to a predetermined position, the control section displaces the operation member and restricts rotation of the rotating body.

3. The webbing retractor of claim 2, wherein the operation member is provided at the rotating body, and also serves as a pawl that, at a time when the rotating body is rotated in the pull-out direction at a predetermined speed or greater, is displaced and anchors the rotating body.

4. The webbing retractor of claim 2, further comprising:
an inertial mass body that can roll due to inertia at a time of vehicle deceleration,
wherein the operation member also serves as a lever that hangs over the inertial mass body, and that, due to rolling of the inertial mass body, is displaced and anchors the rotating body.

5. The webbing retractor of claim 2, comprising:
an electromagnetic actuator that operates the operation member,
wherein the control section energizes the electromagnetic actuator and displaces the operation member.

6. The webbing retractor of claim 5, wherein the electromagnetic actuator is a self-holding actuator that, in a case in which the operation member is displaced and rotation of the rotating body is restricted, can maintain a displaced state of the operation member.

7. The webbing retractor of claim 1, wherein
the sensing section is a rotation angle sensor that detects a rotation angle of the take-up shaft as the pulled-out state, and
the control section uses a state, in which the rotation angle has reached a threshold value, as the state in which the webbing is pulled-out to a predetermined position.

8. The webbing retractor of claim 1, wherein
the sensing section has a pulled-out amount sensor that detects a pulled-out amount of the webbing as the pulled-out state, and
the control section uses a state, in which the pulled-out amount has reached a threshold value, as the state in which the webbing is pulled-out to a predetermined position.

9. The webbing retractor of claim 1, wherein
the control section has a memory, and
in a situation in which the webbing is pulled-out to the predetermined position and the restricting member is in an operated state, in a case in which an ignition of the vehicle is turned OFF, the control section stores, in the memory, operation information relating to the operated state, and
at a time when the ignition of the vehicle is turned ON, in a case in which the operation information is stored in the memory, the control section sets the restricting member in the operated state even if the webbing is not pulled-out to the predetermined position.
